(19) United States
(12) Patent Application Publication
(10) Pub. No.: US 2010/0252725 A1
(43) Pub. Date: Oct. 7, 2010

(54) LOGGING TOOL AND METHOD FOR DETERMINATION OF FORMATION DENSITY

(75) Inventor: Kirk Stewart, Red Deer (CA)

Correspondence Address: MILLEN, WHITE, ZELANO & BRANIGAN, P.C., 2200 CLARENDON BLVD., SUITE 1400, ARLINGTON, VA, 22201, US

(73) Assignee: RECON PETROTECHNOLOGIES., LTD., Calgary, ALberta (CA)

(21) Appl. No.: 12/417,332

(22) Filed: Apr. 2, 2009

(51) Int. Cl. G01V 5/12

(52) U.S. Cl. 250/269.3

(57) ABSTRACT

In connection with a downhole density logging method and tool, the gamma ray source and detectors are substantially non-shielded (that is, they are omni-directional). As a result the gamma ray emission produced by the ‘omni-directional’ source is non-collimated and the back-scattered gamma rays counted by the omni-directional detectors are also non-collimated. Testing has shown that density logging through well casing is viable using this system.

### TECHNICAL FIELD

The present invention relates to gamma-gamma logging through a wellbore penetrating a subterranean earth formation, for the purpose of measuring the bulk density of the formation. More particularly it relates to a logging method and a logging tool used in connection therewith.

### BACKGROUND

Gamma-gamma logging is also referred to in the art as ‘bulk density’ or ‘density’ logging—the last term will be used herein.

Density logging methods and tools are commonly in use for assessing or measuring the apparent bulk density of subterranean formations along the traverse of a wellbore.

Measurement of the apparent bulk density of an earth formation has applications in determining the fractional volume of pore space in the earth formation that may contain oil or gas, determining the overburden force of an earth formation at any particular depth, and determining the mineral composition of an earth formation, amongst other things.

In general, conventional density tools typically comprise: a radioactive gamma ray source, for irradiating a target region in the earth formation with a collimated beam or emission of gamma rays; and one or more collimated gamma ray detectors for collimating and producing a count-rate or measurement of scattered gamma rays detected by the detector. This count-rate is indicative of the electron density of the earth formation, which is directly related to the bulk density for most materials found in an earth formation.

In greater detail, a radioactive chemical source, typically ¹³⁷Cs, bombards the earth formation with gamma rays having an energy of 0.662 MeV. The gamma rays interact with the electrons present in the formation and become either “scattered” or absorbed (through processes known as “Compton scattering” or “photoelectric absorption”, depending upon the energy lost during the collision process). A third process, “pair production”, only becomes significant at energies above 1 MeV. Some gamma rays are scattered back towards the wellbore. This phenomenon, also known as “back-scattering”, allows the detector(s) to detect and establish a count-rate of scattered gamma rays returning to the tool. The count-rate data can then be analyzed and utilized in known ways to deduce density information about the formation.

One prior art tool and its mode of operation are shown in FIGS. 1-3. This tool is primarily used in non-cased or “open” holes and is typically representative of those heretofore used commercially in the density logging art. In greater detail:
Having reference to prior art FIGS. 1a-1e, an “insert” A is provided. The insert A supports an electronic circuitry board B at one end and comprises a pair of serially arranged gamma ray detectors C. Hereinafter the two detectors and circuitry board are collectively referred to as the ‘detector section’ D. The detector section chassis forms a collimating port or “window” F opposite each of the individual gamma ray detectors. In assembly, the detector section D is inserted into one end of a tubular “shield” G. The shield is formed of dense material and has collimating windows S aligned with the detector section windows F. This shield is hereinafter referred to as the ‘detector shield’. It functions to prevent the transmission of gamma rays therethrough, except through the windows. A source H of gamma radiation is provided. The source comprises a radioactive “pill” (not shown) encapsulated in a sealed source assembly J having a collimating window K—see prior art FIG. 1c. The detector shield G, which contains the detector section D, is inserted into one end of a hollow carbide-coated titanium pad L. The source H is inserted into the pad from its other end. The side wall of the pad L forms three collimating windows M that align with the collimating windows of the shield G and the source assembly H. The titanium pad functions as a pressure housing to protect the detector section, detector electronics, shield and source from the wellbore environment. The windows M of the pad L are not carbide coated, thus allowing for the emission and re-entry of gamma ray radiation therethrough. As shown in prior art FIG. 2, the resultant titanium pad assembly is then incorporated into the main logging tool assembly O. This assembly O has means P for eccentering the titanium pad L against the borehole wall Q. Such means P comprise a motorized assembly (not shown), for pushing the pad L against the borehole wall Q, and an offsetting caliper arm R for assistance in maintaining eccentralization in the borehole;
the radioactive pill used in density logging provides a “strong” source of gamma radiation. Typically it is formed of Cs¹³⁷, having a radioactivity in the order of 1.5 to 2 Curies. It is operative to emit high energy gamma rays (energy of 0.662 MeV);
the detectors C are shielded against direct axial radiation from the source H by dense solid material provided therebetween;
the source window K and corresponding shield and pad windows S,M function to shape the emission of gamma rays into a collimated beam T directed at the formation W, as fancifully illustrated in prior art FIG. 3;
each detector C typically comprises: a scintillation crystal of sodium iodide (NaI) which, when contacted by the beam U of scattered gamma rays, produces light flashes proportional to the incident gamma ray energy; a photomultiplier, optically coupled to the crystal, transforms the flashes into electrical pulses; and electronic circuitry provides: a high voltage power supply for the detectors, gamma ray pulse conditioning means, gamma ray pulse discrimination means and line drivers;
the combination of detector window F and corresponding shield and pad windows S,M functions to collimate back-scattered gamma rays emanating from the formation and arriving at the detector and funnels them in the form of a collimated beam to the detector crystal;
the detectors are spaced at different distances from the source—the detector nearest to the source is referred to as the SS detector and the further detector is referred to as the LS detector;
the source window K is oriented with the objective of directing the emitted gamma radiation beam T at a target region V in the earth formation W, essentially “seeing” a small, pie-shaped portion of the formation—see FIG. 3; and
the source and SS detector windows are angularly oriented with the objective of directing the emitted gamma radiation beam T into the near-wellbore region X and capturing scattered gamma rays emanating from that region;
The LS detector window is not angularly oriented and runs parallel to the wellbore face with the objective of measuring scattered gamma radiation from deeper in the formation beyond the near-wellbore region; and
The SS detector readings are used to apply a correction for mud-cake thickness and density to the LS detector readings.

From the foregoing, it will be noted that the source and detectors are shielded or encapsulated in dense or high Z material and windows are provided to collimate the gamma ray emission and the scattered gamma ray returns into the form of focussed, columnar beams of small cross-section.

This prior art density logging tool is therefore designed, in part, to operate by: focussing the gamma ray radiation being emitted to maximize the depth of penetration into the formation; and thereby endeavouring to ensure that enough scattered gamma rays reach the detectors to produce an adequate count-rate.

In use, the described tool is “decentralized” when traversed past a formation of interest. More particularly, the tool pad is typically associated with mechanically actuated arm means which displace the pad L laterally and press it against the surface of the wellbore (See FIG. 2). Pressing the pad against the formation is done with the aim of reducing count-rate distortion incurred from the different densities of the drilling fluid and mud cake present in the wellbore annulus and coping with rugosity or variation in wellbore diameter. These distortions are collectively referred to in the art as “near-wellbore effects”.

It will be noted that the prior art tool described will scan only a small target volume on one side of the wellbore.

By using two gamma ray detectors spaced apart at different distances from the source, the prior art density tool can produce a formation bulk density log that has been compensated to some extent in a known manner for the near-wellbore effects. To compensate for these effects, the SS detector is spaced close to the source, so as to be primarily sensitive to gamma rays that have been scattered in the near-wellbore region. The LS detector is spaced further from the source, so as to be primarily sensitive to gamma rays that have been scattered in the formation. The outputs of the SS and LS detectors are used in generating a log indicative of apparent formation bulk density that has been corrected for near-wellbore effects through the use of a “spine and ribs” correction known in the art. This correction is performed in the logging data acquisition system in the wireline unit associated with the logging tool.

It will be appreciated then that the sequential variation in density of materials across the near-wellbore region impacts upon the scattering of gamma rays and the resulting density readings information produced by the detector(s). The prior art design therefore endeavors to minimize the stand-off between the gamma ray source and detector(s) on the one hand, and the wellbore face and surrounding formation on the other, by decentralizing the pad. However, in spite of such precaution, the detected count-rates of the conventional tools are still adversely affected by the near-wellbore effects.

Furthermore, these conventional pad-type tools have not proven effective in cased wellbores due to the added presence of the steel casing wall and cement in the annulus, which introduce additional density changes. This problem is exacerbated where washouts have occurred behind the casing.

The present invention has been developed with the objective of providing a system which can be used in either cased or uncased wellbores.

### SUMMARY OF THE INVENTION

The present density logging tool and method incorporate the following combination of features:
utilization of a gamma ray source operative to emit a non-collimated emission of gamma ray radiation; and
utilization of one or more pairs of gamma ray detectors operative to establish measurements of the count-rates of non-collimated scattered gamma rays, produced from the formation in response to the irradiation, and detected by the detector(s).

In one aspect the invention provides a downhole density logging method for obtaining information indicative of the bulk density of a subterranean earth formation penetrated by a wellbore, comprising:
irradiating the formation with a non-collimated emission of gamma ray radiation produced by a gamma ray source; and
establishing measurements, such as count-rates, of non-collimated scattered gamma rays produced by the formation in response to such irradiation and detected by a pair of gamma ray detectors.

In another aspect the invention provides a downhole density logging tool comprising:
a non-collimated gamma ray source operative to irradiate a subterranean formation with a non-collimated emission of gamma ray radiation; and
a pair of non-collimated gamma ray detectors spaced axially from the source, each operative to detect and measure a count-rate of non-collimated scattered gamma rays produced by the formation in response to such irradiation.

Optionally, one or more of the following features may also be included:
the gamma ray source and detectors are omni-directional or substantially non-shielded;
the source activity used is relatively weak in comparison to that used conventionally for density logging;
the tool is centralized in the wellbore in the course of logging; and
a plurality of pairs of omni-directional detectors preferably are used, the detectors of each pair being axially aligned with and spaced at different distances from the source, the distances being selected to ensure the detectors are able to detect and measure non-collimated scattered gamma rays.

Testing has shown that:
the present tool and method (referred to collectively as a ‘system’) work effectively in a cased wellbore to produce a bulk density log which compares favourably with a bulk density log previously obtained in open hole conditions in the same wellbore using a prior art bulk density logging system;
the present tool and method work effectively in an open hole wellbore to produce a useful bulk density log;
conventional gamma ray detectors can be effective when substantially non-shielded and used in the tool with a weak source;
a much greater volume of formation is irradiated by the emission that is produced by the present tool, relative to the prior art tool utilizing collimation; and
the near-wellbore effects, even including the effect of the casing, cement and hole rugosity, have been resolved sufficiently for the present tool and method to be useful.

For purposes of this specification, the following terms have the following meanings:
“substantially non-shielded” means that each of the source and detectors are shielded only to the extent needed to effectively prevent radiation moving up or down axially along the tool to deleteriously affect the working of the detectors, but are otherwise generally non-shielded on the sides so as to respectively emit or collect gamma rays in a non-collimated manner. They are thus substantially omni-directional or non-collimated in nature; and
“generally spherical” means that the emission has a configuration, substantially as shown in FIG. 5.

In summary, a density logging tool and method is used for scattered gamma ray measurements useful in calculating formation bulk density, in either open hole or cased wellbores. A substantially non-shielded or omni-directional gamma ray source is utilized to irradiate the formation with a non-collimated emission of gamma rays. A plurality of substantially non-shielded or omni-directional gamma ray detectors are used to establish count-rates of scattered gamma rays reaching the detectors. The scattered gamma ray measurements are useful for calculating formation bulk density of the formation being logged.

### DESCRIPTION OF THE DRAWINGS

FIGS. 1a-1e show a prior art density tool in various stages of assembly;

FIG. 1a is a top view of a gamma ray insert comprising two gamma ray detectors forming a detector section and associated with an electronic circuitry board, said detectors each having a collimating window;

FIG. 1b is a top view showing the insert of FIG. 1a positioned beside a shield having collimating ports or windows;

FIG. 1c is a side view showing a prior art sealed source assembly;

FIG. 1d is a top view showing the detector section inserted into the shield to provide a detector assembly wherein the shield windows align with the detector section windows and the sealed gamma ray source (not shown), said detector assembly being positioned beside a density pad having three gamma ray—transparent windows;

FIG. 1e is a top view showing the density pad with the detector assembly of FIG. 1d inserted into one end of the pad and the sealed source assembly of FIG. 1c inserted into the other end, so that two of the collimating windows are aligned across the two gamma ray detectors and the third window is aligned relative to the position of the sealed gamma ray source (not shown);

FIG. 2 is a schematic side view of a prior art density logging tool having its density pad extended outwardly and pressing against an open hole borehole wall penetrating a downhole formation;

FIG. 3 is a schematic side view fancifully illustrating a sample volume of formation as it might be irradiated by a collimated emission beam, in accordance with the prior art;

FIG. 4 is a schematic side view of the density tool in accordance with the present invention;

FIG. 5 is a fanciful representation of the emitted non-collimated radiation and scattered gamma ray returns as envisaged being generated by the present tool;

FIG. 6 is a side view of an omni-directional source used in the present tool;

FIG. 7 is a schematic side view of the logging assembly as run in the test wellbore; and

FIG. 8 is a print of a segment of the gamma ray, collar locator, density, and neutron count-rate logs produced in the course of the run described in Example I.

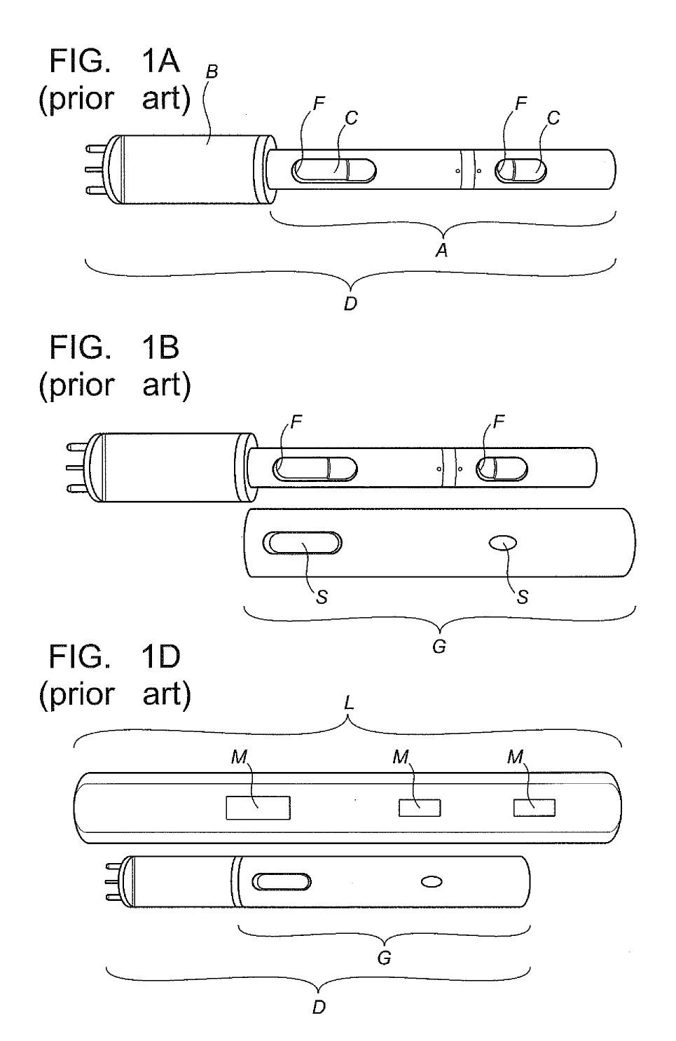

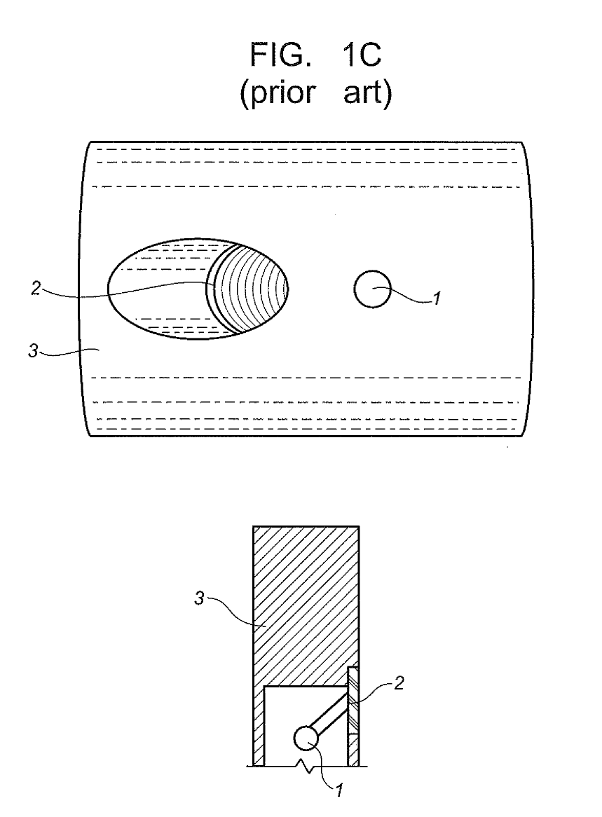

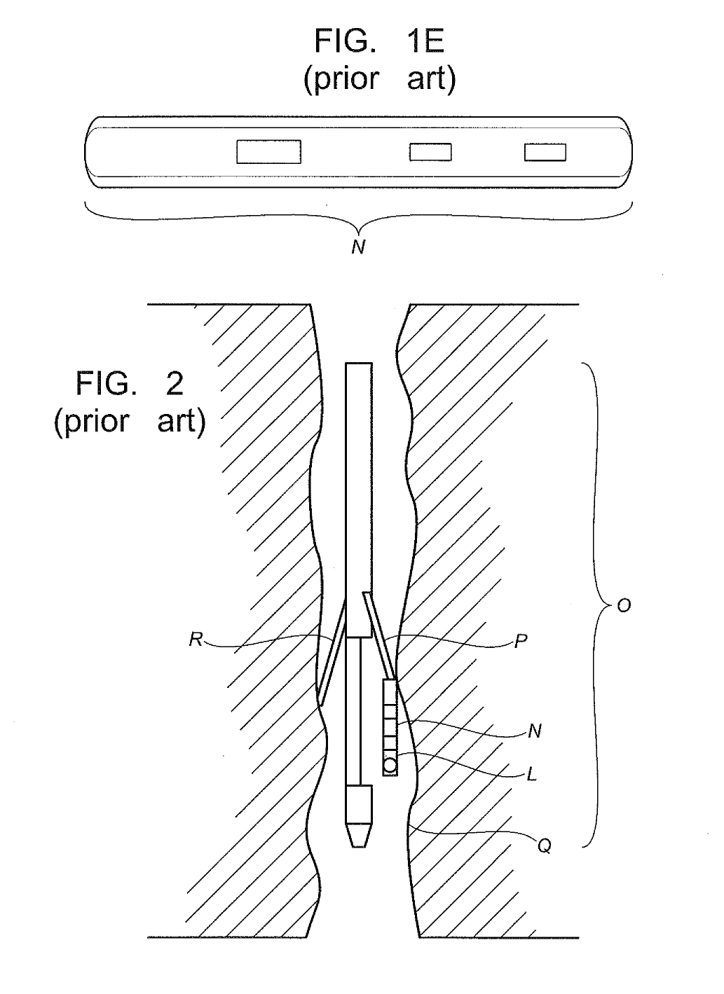

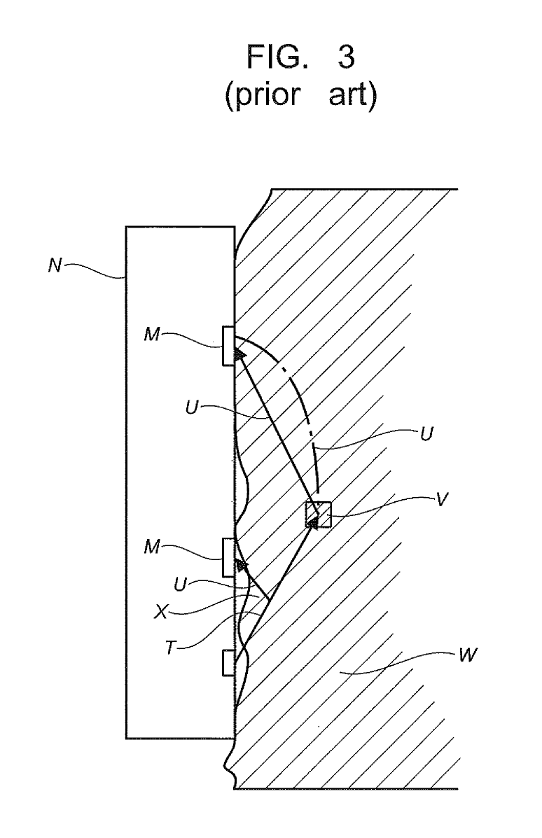

### DESCRIPTION

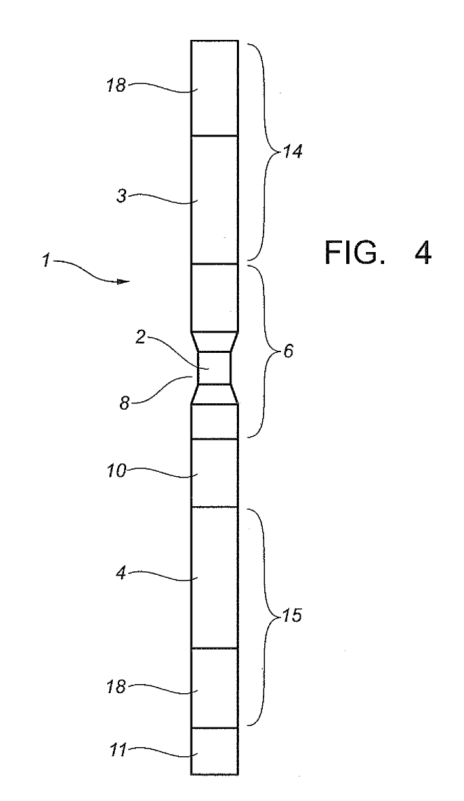

Having reference to FIG. 4, a preferred embodiment of the present logging tool 1 will now be described.

The logging tool 1 comprises a substantially non-shielded, gamma ray radiation source assembly 2 and a pair of LS and SS gamma ray detectors 3, 4, also substantially non-shielded. The detectors 3, 4 are shown positioned above and below the source assembly 2 in axial alignment therewith.

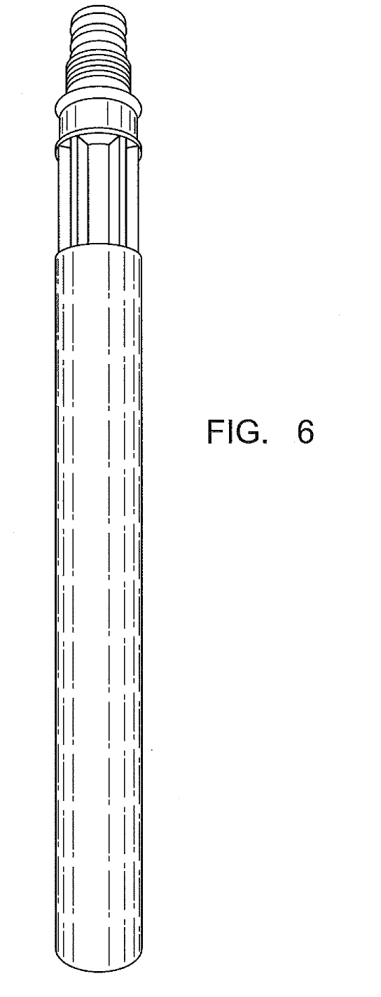

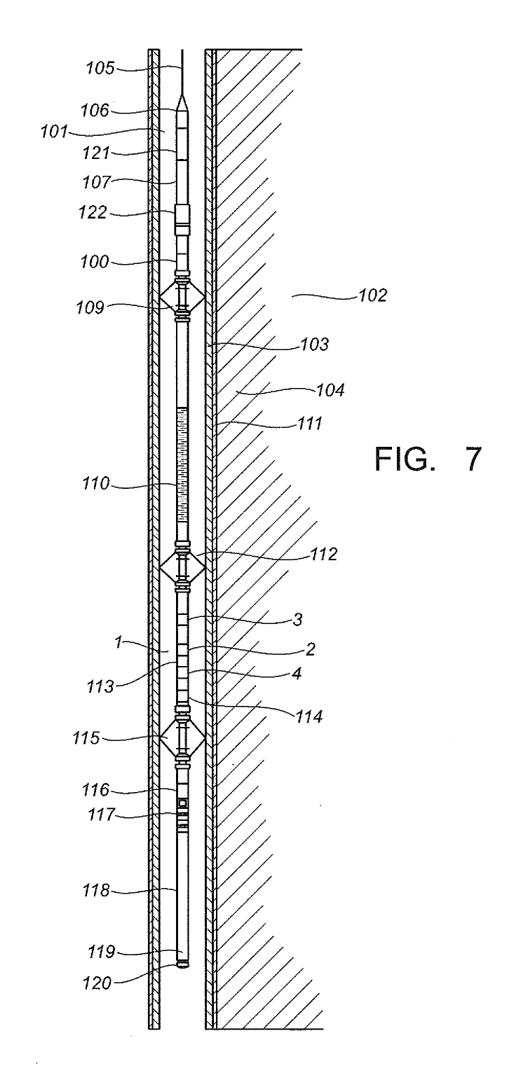

The source 2 used comprises a ‘weak’ radiation source, such as a 30 mCi (1.11 GBq) Cs¹³⁷ radioactive pill. The radioactivity levels of sources used with the present system are selected so as to be compatible with the detectors. Typically they will have an activity level substantially less than the conventional density logging source activity of 1.5 Curies. The pill (not shown) is encapsulated in a sealed source sub assembly 6, illustrated in FIG. 6. The side wall 7 of the source sub assembly 6 is partially cut away to form a ribbed 360° ‘omni-directional’, non-restrictive window 8 extending around the gamma ray source. The source sub assembly 6 incorporates high Z material shielding, but only for attenuating gamma radiation from moving axially upwardly along the tool 1 toward the gamma ray LS detector 3. A tungsten spacer 10 is positioned between the source sub assembly and the lower SS detector 4.

As previously stated, the activity of the gamma ray source 2 is relatively weak relative to that of the previously described prior art tool.

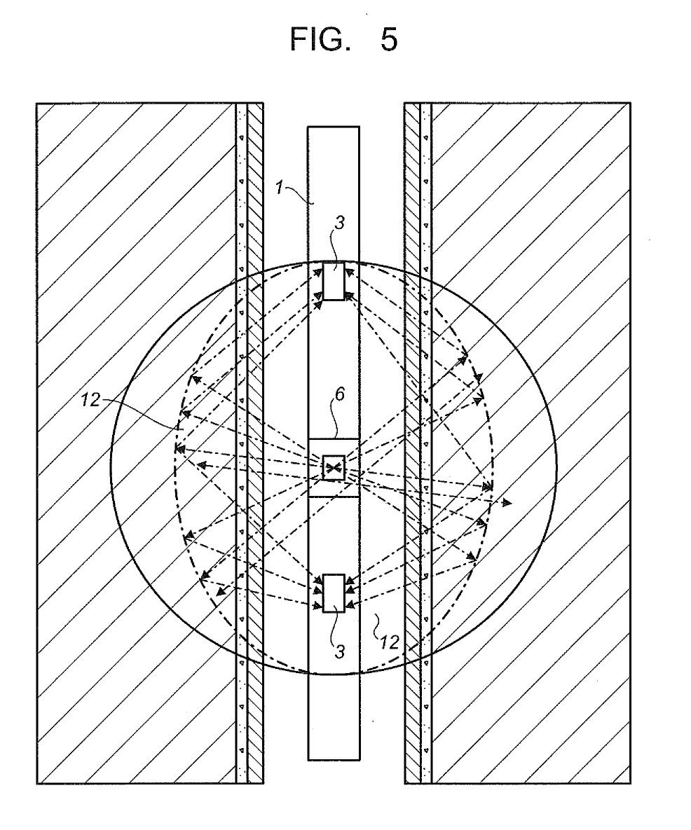

Due to its non-restrictive window structure, the source sub assembly 6 is operative to emit a cloud-like emission 12 of non-collimated gamma ray radiation, substantially as fancifully illustrated in FIG. 5.

The LS detector 3 is a gamma ray scintillation unit. It is positioned at a distance, such as 451.0 mm (17.8 in.), from the gamma ray source 2. The conventional detector components and associated electronics are contained in a pressure housing 14 which is substantially transparent to scattered gamma rays.

The SS detector 4 also is a scintillation unit. The SS detector 4 is inverted to its normal operating position in order to bring it close enough to be well within the radiation field. It is positioned at a distance, such as 254.0 mm (10.0 in.), below the gamma ray source 2. Its pressure housing 15 is also substantially transparent to scattered gamma rays.

The LS and SS detectors 3, 4 used each come from the supplier as a unitary package comprising a pressure housing containing a conventional high voltage power supply, a photomultiplier tube, a sodium iodide crystal, pressure seal and connectors. The detectors 3, 4 are operatively connected with an electronics section comprising a pressure housing containing a conventional telemetry logic circuit board, detector and line interface circuit board, pressure seal and connectors.

In summary, the source 2 and gamma ray detectors 3, 4 used are:
not fully shielded and provided with restrictive collimating windows, so as to collimate the emission and re-entry of scattered gamma rays—instead they are non-collimated in nature; and
the source pill is relatively weak so as not to saturate the detector crystals.

The units are connected in series and are equipped for electrical continuity in the conventional manner.

The method may incorporate the use of one or more pairs of LS and SS uncollimated detectors, having regard for placement of the detectors within the cloud of gamma ray radiation emitted from the uncollimated gamma ray source. The scattered gamma ray measurements or count-rates are used, in connection with one or more calibration relationships, to derive a formation bulk density and compensate for wellbore conditions.

While specific source and detector units, activity level, detector positioning and spacings have been disclosed, those skilled in the art will appreciate that alternative equivalent units are known in the art and may be substituted; also, the gamma ray source activity level, gamma ray detectors locations relative to the source and spacings may be adjusted—such changes are contemplated to be within the scope of the claims.

### EXAMPLE I

A density logging tool 1, embodying the present invention, was tested in a logging run in a cased wellbore 101. The tool 1 was incorporated into a logging assembly 102 shown in FIG. 7. The wellbore 101 had previously been logged using a prior art formation density tool and the density log 200 was available for comparison. The formation density tool had been run when the wellbore was still open hole—that is, the casing 103 was not yet present. The purpose of this test was to assess the viability of the density log 201 produced by the present tool when run in the cased wellbore 101 by comparing it with the density log 200 which had been run when the wellbore was not cased.

The casing 103 present in the wellbore 101 was 114.3 mm, 14.14 kg/m J-55 casing (that is, 4½″ by 9.5 lbm/ft casing). The casing was cemented in place in a 159.0 mm (6¼″) borehole 104. The casing was filled with fresh water having a fluid density of 998.0 kg/m³ (8.33 lbm/gal).

The components used were primarily obtained from Sondex Limited, a well-known supplier of logging equipment. (Hereinafter referred to as “Sondex”).

Having reference to FIG. 7, logging assembly 102 comprised, from top to bottom:
a 0.125″ slickline 105;
a slickline swivel joint and rope socket 106;
a battery pack 121, obtained from Sondex under the designation MBH-024, for housing batteries for powering the logging assembly 102 and memory tool 107;
a Sondex Ultrawire™ memory tool 107, obtained under the designation UMT 004 or UMT003, for acquiring and recording the produced data;
a Sondex Ultrawire™ casing collar locator 122 for recording casing collars for depth correlation;
a Sondex Ultrawire™ production gamma ray tool 100, obtained under the designation PGR020 or PGR021, for recording natural gamma ray radiation from the formation for depth correlation;
a Sondex™ four-arm roller centralizer 109, obtained under the designation 1.6875 Slim 1520002, for maintaining centralization of a cement bond tool 110 in the casing;
a Sondex Ultrawire™ radial cement bond tool 110, obtained under the designation RBT-003, for evaluating the cement bond quality and locating voids in the cement 111 behind the casing 103;
a Sondex™ four-arm roller centralizer 112, available under the designation 1.6875 Slim 1520002, for maintaining centralization of the cement bond tool 110 and the long-space detector 3;
a second Sondex Ultrawire™ production gamma ray tool, used as the long-space detector 3 and assigned a memory channel that did not conflict with the correlation Ultrawire™ production gamma ray tool 100, and which is available under the designation PGR020 or PGR021;
a Sondex™ gravel pack source sub assembly 2, available under the designation Source Sub Assembly Gravel Pack Tool 1½″ SX, that housed the ¹³⁷Cs gamma ray source, available from AEA Technology QSA Inc. under the designation CDC807;
a 43.0 mm×127.0 mm (1 11/16″×5.0″) tungsten-shielded cross-over sub 113 for connecting the gravel pack source sub assembly 2 to an Ultrawire™ production gamma ray tool below the Source Sub Assembly;
an inverted Sondex Ultrawire™ production gamma ray tool, used as the short-space detector 4, available under the designation PGR020 or PGR021, which was assigned a memory channel that did not conflict with the correlation Ultrawire™ production gamma ray tool 100 or the long-space detector Ultrawire™ production gamma ray tool;
a 43.0 mm×101.6 mm (1 11/16″×4.0″) cross-over sub 114, for connecting additional Sondex Ultrawire™ instrumentation below the short-space detector Ultrawire™ production gamma ray tool;
a Sondex™ four-arm roller centralizer 115, available under the designation 1.6875 slim 1520002, for centralizing the short-space Ultrawire™ production gamma ray tool;
a Sondex Ultrawire™ fluid density tool 116, available under the designation FDR019 or FDR020, for recording the fluid density in the casing;
a Sondex™ production knuckle joint 117, available under the designation PKJ027, for decentralizing a Sondex Ultrawire™ compensated neutron tool 118 in the casing;
a Sondex Ultrawire™ compensated neutron tool 118, available under the designation Ultrawire™ CNL, for estimating formation porosity;
a neutron source sub 119, integral with the CNL tool 118, for housing a sealed neutron source; and
a Sondex Bullnose Ultrawire™ terminator 120, available under the designation BUL 006, for terminating the Ultrawire™ telemetry signal.

An in situ calibration of the LS and SS detector count-rates was carried out to derive a bulk density correlation. This was performed by taking the count-rate ratio SS/LS and fitting the data response to the open-hole density response derived from a previous open hole bulk density log obtained from the same well.

A calibration of the LS detector was performed using known and accepted calibration methods to derive bulk density. This was also performed as a “proof of principle” measurement and verification that the measured responses to determine the bulk density through casing could be calibrated using known, acceptable methods. The procedure used was to calibrate to two end points of known density, such as water (RHOB=1.0 gm/cc) and limestone (RHOB=2.71 gm/cc). As density tools measure electron density which is then converted to bulk density, the end-points of water and limestone used for calibrating density tools are the electron density of each respective medium. The relationship between bulk density and electron density is expressed by the equation; ρₑ=ρ_{b}(2Z/A), where, ρₑ=electron density, ρ_{b}=bulk density, Z=atomic number and A=atomic weight. Outside of hydrogen, the relationship for most elements encountered in a wellbore have a (2Z/A) value of approximately 1. In order to calibrate the tools to the known electron density of the medium, the electron density of the medium must be known and for water and limestone is as follows;

Water, H₂O and ρ_{b}=1.00 gm/cc;

ρₑ=(1.00) (2) [2+8/2.016+16]=1.1101

Hydrogen has an atomic weight (A) of 1.008 and an atomic number (Z) of 1. Oxygen has an atomic weight (A) of 16.00 and an atomic number (Z) of 8.00.

Limestone, CaCO₃ and ρ_{b}=2.71 g/cc;

ρₑ=(2.71) (2) [20+6+(3) (8)/40.04+12.011+(3) (16)]=2.7076.

Calcium has an atomic weight (A) of 40.04 and an atomic number (Z) of 20.

Carbon has an atomic weight (A) of 12.011 and an atomic number (Z) of 6.

Oxygen has an atomic weight (A) of 16.00 and an atomic number (Z) of 8.

As will be understood from the foregoing, bulk density tools are calibrated to read a ρₑ of 1.1101 in water and ρₑ of 2.7076 in limestone. A linear conversion is used to translate electron density to bulk density: ρ_{b}=1.0704ρₑ−0.1883.

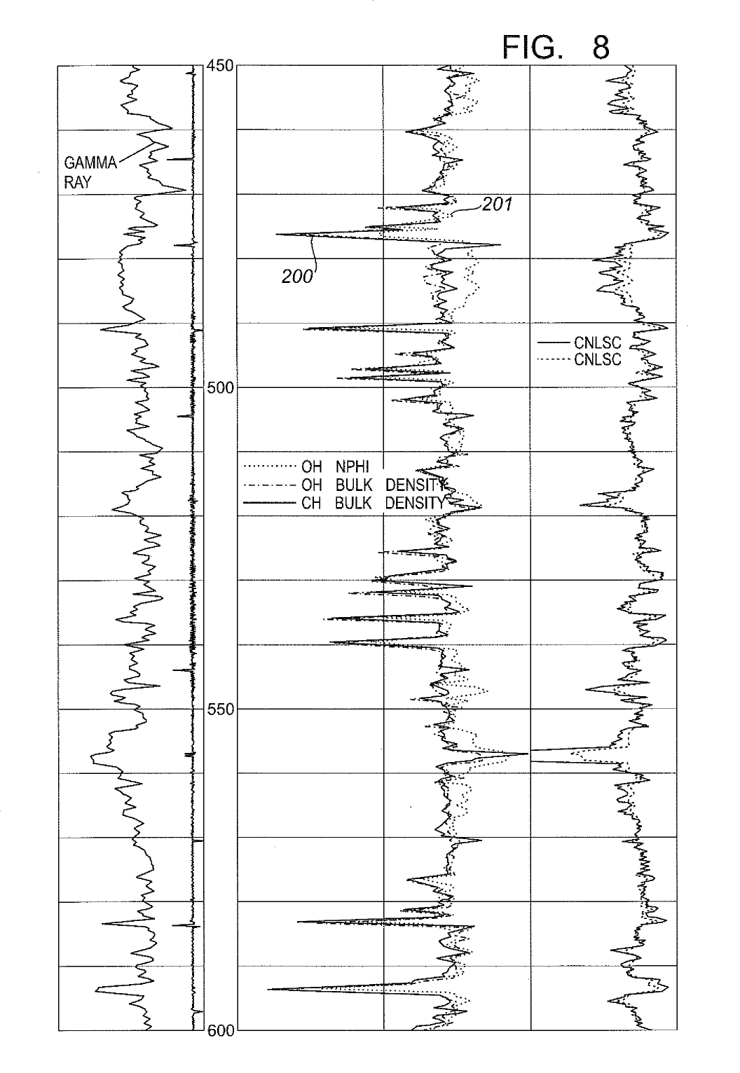

In order to calibrate the LS and SS detector responses, models representing the above should be used; however, as none were available, some points were selected from a set of log data, where a limestone rock was encountered. A water tank calibration was performed to gain a water end-point and correlate the response to the electron density as described above and then apply the linear conversion of ρ_{b}=1.0704ρₑ−0.1883 to the data. This fit is shown in FIG. 8. The “calibrated” response tracked quite well to the actual bulk density acquired from a “certified” tool that had been calibrated to known standards. The foregoing indicated that the response was valid through casing and cement, using known calibration methods acceptable to those familiar with the art.

In a second test, the same assembly was run in an open hole, with similar acceptable results.

These test runs and dimensional considerations established:
1) that the present logging tool and method are capable of measuring bulk density in both cased and open hole applications;
2) that the effects of the near wellbore region that affect conventional pad-type tools were not seen—therefore, one can conclude that a deeper depth of investigation is being achieved;
3) that the system appears to not be affected by the near wellbore region response as it has not required a correction to be applied to the bulk density values, based on the data acquired to date;
4) that the system mitigates the response of casing collars (couplings that join the joints of casing together), unlike pad-type tools that exhibit large density “spikes” across the collar regions;
5) that the present tool can be run in small diameter pipe and through wellheads, which can be problematic with the conventional pad-type tools;
6) that the present tool can be deployed through tubing to log in casing or open hole below the tubing bottom, thus not requiring a service rig to kill the well, pull the tubing, re-run the tubing after logging and swab the well back into production;
7) that the present tool can be deployed into live (pressurized) wells without having to kill the well;
8) that the present tool can be deployed through drill pipe and drill collars;
9) that a low-activity ¹³⁷Cs source or ⁶⁰Co source may usefully be used to irradiate a downhole formation in the course of determining bulk density;
10) that an unfocused, low-activity gamma-ray source may usefully be used to irradiate a downhole formation in the course of determining bulk density;
11) that the present tool does not need to be decentralized and pressed against the borehole wall to measure bulk density;
12) that the present tool does not require collimization to measure bulk density;
13) that the present tool does not require the backscattered gamma-ray radiation to be parallel to the gamma-ray detectors as is the case with a pad-type device;
14) that the present tool measures a larger volume of backscattered gamma-ray radiation as witnessed by the reduced source activity (30 mCi) used, as compared to the source activity (1.5Ci to 2Ci) used with a pad-type collimated tool and the correlatable results of this to known bulk density measurements;
15) that the present system does not require a measure of the borehole axis (X-Y Caliper) to correct the bulk density measurement, as required with the conventional pad-type tools; and
16) that the present system does not require a “spine and ribs” correction to be applied in order to correct the bulk density measurement, as required with the conventional pad-type tools.

1. A downhole density logging method for obtaining information indicative of the bulk density of a subterranean earth formation penetrated by a wellbore, comprising:
irradiating the formation with a non-collimated emission of gamma ray radiation produced by a gamma ray source; and
establishing measurements of non-collimated scattered gamma rays which have been produced by the formation in response to such irradiation and detected by a pair of gamma ray detectors.

2. The method of claim 1 wherein:
each of the source and detectors are substantially non-shielded.

3. The method of claim 2 wherein:
the gamma ray detectors are positioned at different distances from the source, said distances being selected to ensure the detectors are able to detect and establish scattered gamma ray measurements.

4. The method of claim 3 wherein:
the detectors are spaced relative to the source in axial alignment therewith.

5. The method of claim 4 wherein the source and detectors are centrally located within the wellbore.

6. The method of claim 5 wherein the wellbore is cased.

7. The method of claim 5 wherein the wellbore is an open hole.

8. The method of claim 6 wherein the source radioactivity is less than 1.5 Curies and selected to be compatible with the detectors.

9. The method as set forth in claim 8 wherein the detected scattered gamma rays are primarily Compton-scattered gamma rays.

10. The method of claim 9 comprising traversing the source and detectors through the wellbore across the formation whose density is to be assessed.

11. The method as set forth in claim 10 wherein the source radioactivity is in the order of 30 millicuries.

12. The method of claim 9 wherein:
the source emits a generally spherical emission of non-collimated gamma rays.

13. The method as set forth in claim 9 comprising measuring the count-rates of the non-collimated, detected, scattered gamma rays.

14. A downhole density logging tool comprising:
a non-collimated gamma ray source operative to irradiate a subterranean formation with a non-collimated emission of gamma ray radiation; and
a pair of non-collimated gamma ray detectors spaced axially from the source and operative to measure the count-rates of non-collimated scattered gamma rays produced by the formation in response to such irradiation.

15. The tool as set forth in claim 14 wherein the source and detectors are each substantially non-shielded.

16. The tool as set forth in claim 15 wherein:
the gamma ray detectors are positioned at different distances from the source, said distances being selected to ensure the detectors are operative to detect scattered gamma rays.

17. The tool as set forth in claim 16 wherein:
the source has a radioactivity less than 1.5 Curies.

18. A downhole density logging tool comprising:
an omni-directional gamma ray source operative to irradiate a subterranean formation with a non-collimated emission of gamma ray radiation; and
a pair of omni-directional gamma ray detectors spaced axially from the source and operative to measure scattered gamma rays produced by the formation in response to such irradiation.

19. A downhole density logging method for obtaining information indicative of the bulk density of a subterranean earth formation penetrated by a cased or open hole wellbore, comprising:
irradiating the formation with an emission of gamma ray radiation produced by a non-collimated gamma ray source and utilizing a pair of non-collimated gamma ray detectors to detect scattered gamma rays;
in the course of logging the wellbore to obtain the formation density information.

20. The method as set forth in claim 19 wherein:
the source and detectors are centralized in the wellbore.

21. The method as set forth in claim 20 wherein the detectors are positioned at different distances from the source, said distances being selected to ensure the detectors are able to detect and establish count-rates of scattered gamma rays.
